(19) United States
(12) Patent Application Publication
(10) Pub. No.: US 2023/0031178 A1
(43) Pub. Date: Feb. 2, 2023

(54) SYSTEMS AND METHODS FOR HANDLING FAKE NEWS

(71) Applicant: Rovi Guides, Inc., San Jose, CA (US)

(72) Inventors: Vishwas Sharadanagar Panchaksharaiah, Tiptur (IN); Vikram Makam Gupta, Bangalore (IN)

(21) Appl. No.: 17/391,833

(22) Filed: Aug. 2, 2021

(51) Int. Cl. G06Q 30/02; G06Q 20/38; G06Q 50/00; G06F 16/23; G06F 16/22

(52) U.S. Cl. CPC G06Q 30/0215; G06Q 20/389; G06Q 30/0201; G06Q 50/01; G06F 16/2379; G06F 16/2246; G06F 16/2365

(57) ABSTRACT

The present disclosure relates to providing a non-linear data structure stored in a blockchain database. More particularly, the present disclosure provides systems and methods for identifying so-called “fake news” on a media platform. The present disclosure provides a method that leverages data describing news content items to generate a hash value for which a root node of the non-linear data structure is created. Commit data is received and added to the non-linear data structure. The commit data may include verification tags that identify the news content item is true or misleading.

### FIELD OF INVENTION

The present disclosure relates to determining the veracity of online content items. More particularly, the present invention provides an effective tool for identifying, tagging, and remediating false or unreliable content using non-linear data structures stored in blockchain technology.

### BACKGROUND

In today's world, there are innumerable sources of content and data. It is challenging for users to identify what information is valid, and what is false. Some factors that play into the spread of unverified and false information are misidentifying sources of content and data (e.g., an imposter news source created to mimic trusted news sources), sharing articles from known sources of false information, or simply sharing information previously shared by a trusted second user (e.g., person A shares false information, which is shared by person B who trusts person A). The spread of misinformation and so-called “fake news” is accelerated by the panic, fear, and conspiracy-like frenzy the spread of the information creates.

It is also difficult to identify fake news from the outset. This is especially the case in today's online ecosystem because there are many untrustworthy sources and authors. This results in a tremendous amount of fake news or unreliable interpretations of information being embedded into online spaces (e.g., social media platforms) that become difficult to distinguish from reliable content due to the amount of data available and the fact that users may trust other users who share the information. Therefore, the data that is constantly being uploaded onto the Internet and consumed by users may contain false, misleading, or unverified information, which spreads quickly. A method and system for identifying fake news are therefore required.

The generation of irrelevant or misinformative content can particularly be seen concerning any trending event or activity in the real or online world. There are times when content (e.g., a news article) goes viral simply because the article was viewed or retweeted or shared a high number of times in a short period. Such articles can end up prioritized by automated systems in search results since they may be identified as “popular” or “interesting.” A method and system for prioritizing known verified content items are therefore desired, to help prevent the spread of false information.

Through pressure from governing authorities, social networks have been developing algorithms to fight the spread of fake news, currently, there are no indicators to warn users or content consumers that an article is from a reputable source, nor that an article is a known fake news story. A method and system to indicate that a content item is verified as true or false are therefore required.

### SUMMARY

The present disclosure describes the creation of a non-linear data structure (e.g., a Merkle Tree) stored on a blockchain database with a root node that is based on a data set describing a content item, such as a misleading news article. For example, a potentially fake news content item is identified on a media platform and marked for verification, a data set describing the fake news content item (a link to the article, a copy of the viral message, etc.) is received and a root node of a non-linear data structure is created. A trusted user or entity (BBC, SAGE, Sky News, etc.) can verify the story and create a commit data set (e.g., an indication of true/false). The commit data set is received and added to the non-linear data structure. The trusted users can be awarded micro-equity incentives (e.g., crypto-currency) for commit data sets (e.g., a true/false) that are accepted to the blockchain. Further commit data sets could include links to “real” articles that debunk the fake news/provide evidence to the contrary of the fake news. These additional commits may also be awarded micro-equity incentives.

According to a first aspect, a method is provided for creating a non-linear data structure stored in a blockchain database. The method comprises receiving a data set describing a news content item, creating a root node comprising the data set, calculating a hash value for the data set of the root node, storing the hash value of the root node, receiving a commit data set describing changes to the data set describing the news content item, calculating a hash value for the commit data set, storing the hash value of the commit data set, and linking the commit data set hash value to the hash value of the root node as a new branch of the non-linear data structure.

In some examples, the commit data set comprises an indication of a verification status tag. Additionally, in some examples, the verification status tag is one of: relevant, irrelevant, reliable, unreliable, real, fake, true, false, or misleading.

In some examples, the method further comprises performing a Merkle proof to incrementally validate branches of the non-linear data structure to determine if a branch has been modified.

In some examples, the method further comprises accessing a database comprising a reputation score for a plurality of users. In some examples, the commit data set is provided by a first user having a first reputation score. In this way, the method only allows the committing of data sets from known, trusted users with a reputation score above a certain level, adding layer of security aiding in prevention against malicious changes to the blockchain.

In some examples, the method further comprises determining that the first reputation score of the first user is above a threshold. In some examples, storing the hash value of the commit data set and linking the commit data set hash value to the hash value of the root node is in response to the reputation score of the first user being above a threshold. In some further examples, the method further comprises determining that the first reputation score of the first user is below a threshold and rejecting the commit data set from the first user. For example, a user that has a low reputation score would not be able to commit data to the blockchain, because it might comprise incorrect verification of misleading news stories.

In some examples, the method further comprises receiving the commit data set describing changes to the data set describing the news content item from a second user with a second reputation score, determining that the second reputation score of the second user is above the threshold. In some examples, storing the hash value of the commit data set and linking the commit data set hash value to the hash value of the root node is in response to the reputation score of the first user being above a threshold.

In some examples, the blockchain database is maintained via trust-enabled adaptive mining. In some examples, the method further comprises accepting the commit data set describing changes to the data set describing the news content item from a first user and awarding a micro-entity incentive to the first user providing a commit data set.

In some examples, the commit data set is one of a verified true tag, a verified misleading tag, a link to a verified second content item associated with the content item, authorship information, verifier information, or a link to associated news content items.

In some examples, the commit data set comprises one or more of: an indication that the content item is true or false, authorship information, verifier information, or a link to associated news content items, or time stamp data.

In some examples, the method further comprises monitoring a rate of sharing of a content item on a media platform. In some examples, in response to the rate of sharing reaching a threshold, the method comprises creating a data set describing the content item and sending the data set describing the content item for verification. In some examples, in response to the content item being verified as misleading, the method further comprises tagging the content item with a “misleading” news tag on the media platform.

In an alternative aspect, there is provided a system for providing a non-linear data structure stored in a blockchain database. The system comprises means for receiving a data set describing a news content item, means for creating a root node comprising the data set, means for calculating a hash value for the data set of the root node, means for storing the hash value of the root node, means for receiving a commit data set describing changes to the data set describing the news content item, means for calculating a hash value for the commit data set, means for storing the hash value of the commit data set, and means for linking the commit data set hash value to the hash value of the root node as a new branch of the non-linear data structure.

In an alternative aspect, there is provided a non-transitory, computer-readable medium comprising non-transitory, computer-readable instructions encoded thereon for providing a non-linear data structure stored in a blockchain database. The instructions comprise receiving a data set describing a news content item, creating a root node comprising the data set, calculating a hash value for the data set of the root node, storing the hash value of the root node, receiving a commit data set describing changes to the data set describing the news content item, calculating a hash value for the commit data set, storing the hash value of the commit data set, and linking the commit data set hash value to the hash value of the root node as a new branch of the non-linear data structure.

In a second aspect, there is provided a method for identifying misleading news on a media platform. The method comprises monitoring a rate of sharing of a content item on the media platform. In response to the rate of sharing reaching a threshold, the method comprises creating a data set describing the content item and sending the data set describing the content item for verification. The method also comprises receiving an indication of the verification status of the content item and, in response to the content item being verified as misleading, the method further comprises tagging the content item with a misleading news tag on the media platform.

In some examples, in response to the content item being verified as true, the method further comprises tagging the content item with a “verified” tag. In some examples, the method further comprises assigning a first priority to content items with the “verified” tag, assigning a second priority to content items without a “verified” or “misleading” news tag, the second priority being lower than the first priority, and assigning a third priority to content items with a “misleading” news tag, the third priority being lower than the second priority. In some examples, in response to a search being performed on the media platform, the method further comprises prioritizing the search results according to the assigned priority of the content items.

In some examples, the method further comprises preventing further sharing of content items with the “misleading” news tag. In some examples, the method further comprises receiving a hash value for the data set describing the content item tagged with the “misleading” news tag, searching the user device for the hash value of the data set.

In some examples, in response to detecting the hash value of the data set on the user device, the method further comprises pushing a notification to the user device. In some examples, the notification comprises a warning that misleading news was recently consumed on the user's device.

In some examples, the rate of sharing of the content item is based on at least one of popularity, a number of views, a number of likes, a number of impressions, a number of quotes, a number of times forwarded, a number of comments, a number of favorites, or a number of interactions.

In some examples, the method further comprises receiving a data set describing a news content item, creating a root node comprising the data set, calculating a hash value for the data set of the root node, storing the hash value of the root node, receiving a commit data set describing changes to the data set describing the news content item, calculating a hash value for the commit data set, storing the hash value of the commit data set, and linking the commit data set hash value to the hash value of the root node as a new branch.

In an alternative aspect, there is provided a system for identifying misleading news on a media platform. The system comprises means for monitoring a rate of sharing of a content item on the media platform. The system comprises means for creating a data set describing the content item and means for sending the data set describing the content item for verification that are utilized in response to the rate of sharing reaching a threshold. The system comprises means for receiving an indication of the verification status of the content item. The system comprises means for tagging the content item with a “misleading” news tag on the media platform, that is utilized in response to the content item being verified as misleading.

In an alternative aspect, there is provided a non-transitory, computer-readable medium comprising non-transitory, computer-readable instructions encoded thereon for identifying misleading news on a media platform. The instructions comprise monitoring a rate of sharing of a content item on the media platform. In response to the rate of sharing reaching a threshold, the instructions comprise creating a data set describing the content item, and sending the data set describing the content item for verification. The instructions further comprise receiving an indication of the verification status of the content item and, in response to the content item being verified as misleading, the instructions comprise tagging the content item with a “misleading” news tag on the media platform.

It will be appreciated that other features, aspects, and variations of the present invention will be apparent from the disclosure herein of the drawings and detailed description. Additionally, it will be further appreciated that additional or alternative embodiments may be implemented within the principles set out by the present disclosure.

### BRIEF DESCRIPTION OF THE DRAWINGS

The figures herein depict various embodiments of the disclosed invention for purposes of illustration only. It will be appreciated that additional or alternative structures, systems, and methods may be implemented within the principles set out by the present disclosure.

The above and other objects and advantages of the disclosure will be apparent upon consideration of the following detailed description, taken in conjunction with the accompanying drawings, in which:

FIG. 1 shows an illustrative depiction of an example user device, in accordance with some embodiments of the present disclosure;

FIG. 2 shows a block diagram of an illustrative user equipment system, in accordance with some embodiments of the present disclosure;

FIG. 3 is an illustrative block diagram showing a system having a plurality of data structures, in accordance with some embodiments of the present disclosure;

FIG. 4 shows an example data structure, in accordance with some embodiments of the present disclosure;

FIG. 5 is a flowchart of illustrative steps involved in creating a non-linear data structure, and calculating and storing hash values of the nodes of the non-linear data structure, in accordance with some embodiments of the present disclosure;

FIG. 6 is a flowchart of illustrative steps involved in accessing a database comprising a reputation score for a plurality of users and determining if the reputation score for a particular user is above a threshold, in accordance with some embodiments of the present disclosure;

FIG. 7 is a flowchart of illustrative steps in awarding a micro-entity incentive to a user providing a commit data set, in accordance with some embodiments of the present disclosure;

FIG. 8 is a flowchart of illustrative steps involved in determining if the rate of sharing of a content item exceeds a threshold and tagging the content item in response to the content item being verified true or false, in accordance with some embodiments of the present disclosure;

FIG. 9 is a flowchart of illustrative steps involved in assigning a priority tag to a content item based on a verified tag status, in accordance with some embodiments of the present disclosure;

FIG. 10 shows an illustrative diagram of an example user interface comprising a search bar and search results carried out on a user device, in accordance with some embodiments of the present disclosure.

FIG. 11 shows an illustrative diagram of an example content item that has been tagged as fake news on a media platform, in accordance with some embodiments of the present disclosure.

### DETAILED DESCRIPTION

As referred to herein, a “media guidance application” or a “guidance application” is an application that provides media guidance data to a user through an interface. For example, a media guidance application may allow users to efficiently navigate content selections and easily identify content that they may desire. The media guidance application and/or any instructions for performing any of the embodiments discussed herein may be encoded on computer-readable media. Computer-readable media includes any media capable of storing data. The computer-readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (RAM), etc.

As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, rating information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

As referred to herein, the terms “media asset” and “media content” should be understood to mean an electronically consumable user asset, such as a live televised program, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate and locate content.

As referred to herein, the term “multimedia” should be understood to mean content that utilizes at least two different content forms described above, for example, text, audio, images, video, or interactivity content forms. Content may be recorded, played, displayed, or accessed by user equipment devices, but can also be part of a live performance.

As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smartphone, or any other television equipment, computing equipment, or wireless device, and/or combination of the same.

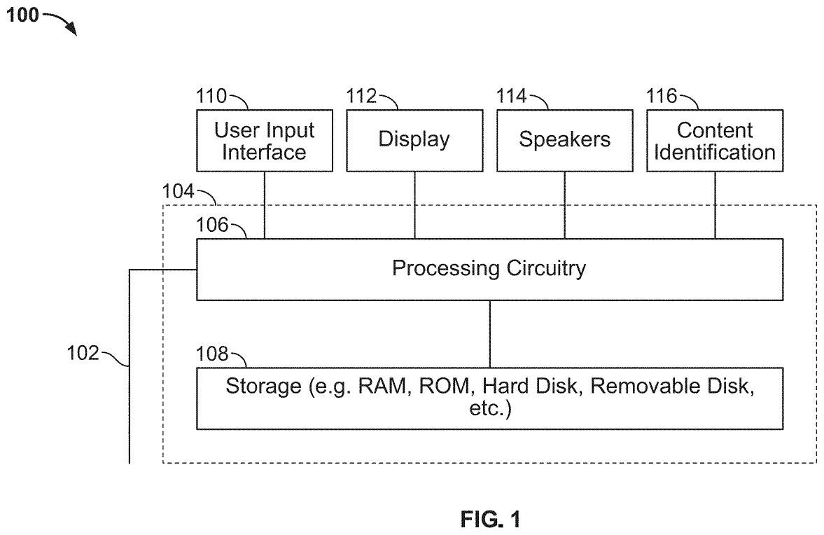

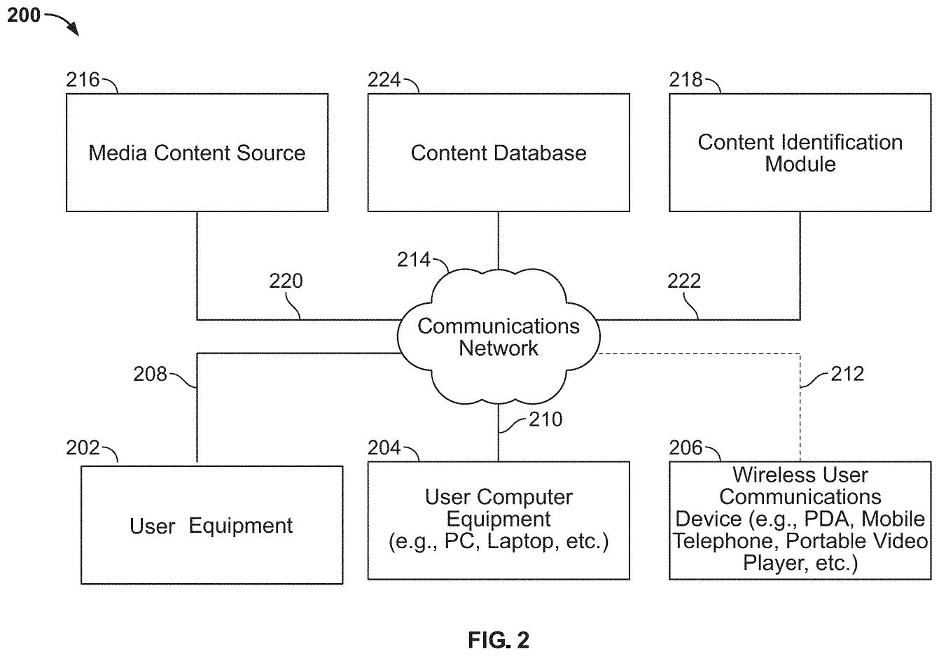

Users may access content and the media guidance application (and its display screens described above and below) from one or more of their user equipment devices. FIG. 1 shows a generalized embodiment of illustrative user equipment device 100. More specific implementations of user equipment devices are discussed below in connection with FIG. 2. User equipment device 100 may receive content and data via input/output (hereinafter “I/O”) path 102. I/O path 102 may provide content (e.g., broadcast programming, on-demand programming, Internet content, the content available over a local area network (LAN) or wide area network (WAN), and/or other content) and data to control circuitry 104, which includes processing circuitry 106 and storage 108. Control circuitry 104 may be used to send and receive commands, requests, and other suitable data using I/O path 102. I/O path 102 may connect control circuitry 104 (and specifically processing circuitry 106) to one or more communications paths (described below). I/O functions may be provided by one or more of these communications paths, but are shown as a single path in FIG. 1 to avoid overcomplicating the drawing.

Control circuitry 104 may be based on any suitable processing circuitry such as processing circuitry 106. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexacore, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 104 executes instructions for a media guidance application stored in memory (i.e., storage 108). Specifically, control circuitry 104 may be instructed by the media guidance application to perform the functions discussed above and below. For example, the media guidance application may provide instructions to control circuitry 104 to generate the media guidance displays. In some implementations, any action performed by control circuitry 104 may be based on instructions received from the media guidance application.

In client-server-based embodiments, control circuitry 104 may include communications circuitry suitable for communicating with a guidance application server or other networks or servers. The instructions for carrying out the above-mentioned functionality may be stored on the guidance application server. Communications circuitry may include a cable modem, integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 2). In addition, communications circuitry may include circuitry that enables peer-to-peer communication of user equipment devices or communication of user equipment devices in locations remote from each other.

The memory may be an electronic storage device provided as storage 108 that is part of control circuitry 104. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder or PVR), solid-state devices, quantum storage devices, gaming consoles, gaming media, or any other suitable fixed or removable storage devices, and/or any combination of the same. Storage 108 may be used to store various types of content described herein as well as media guidance data described above. Nonvolatile memory may also be used (e.g., to launch a boot-up routine and other instructions). Cloud-based storage, described in relation to FIG. 2, may be used to supplement storage 108 or instead of storage 108.

Control circuitry 104 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 104 may also include scaler circuitry for upconverting and downconverting content into the preferred output format of the user equipment 100. Circuitry 104 may also include digital-to-analog converter circuitry and analog-to-digital converter circuitry for converting between digital and analog signals.

The tuning and encoding circuitry may be used by the user equipment device to receive and display, play, or record content. The tuning and encoding circuitry may also be used to receive guidance data. The circuitry described herein, including, for example, the tuning, video generating, encoding, decoding, encrypting, decrypting, scaler, and analog/digital circuitry, may be implemented using software running on one or more general-purpose or specialized processors. Multiple tuners may be provided to handle simultaneous tuning functions (e.g., watch and record functions, picture-in-picture (PIP) functions, multiple-tuner recording, etc.). If storage 108 is provided as a separate device from user equipment 100, the tuning and encoding circuitry (including multiple tuners) may be associated with storage 108.

A user may send instructions to control circuitry 104 using user input interface 110. User input interface 110 may be any suitable user interface, such as a remote control, mouse, trackball, keypad, keyboard, touchscreen, touchpad, stylus input, joystick, voice recognition interface, or other user input interfaces.

Display 112 may be provided as a stand-alone device or integrated with other elements of user equipment device 100. For example, display 112 may be a touchscreen or touch-sensitive display. In such circumstances, user input interface 112 may be integrated with or combined with display 112. Display 112 may be one or more of a monitor, a liquid crystal display (LCD) for a mobile device, amorphous silicon display, low-temperature polysilicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images.

In some embodiments, display 112 may be HDTV-capable. In some embodiments, display 112 may be a 3D display, and the interactive media guidance application and any suitable content may be displayed in 3D. A video card or graphics card may generate the output to the display 112. The video card may offer various functions such as accelerated rendering of 3D scenes and 2D graphics, MPEG5 2/MPEG-4 decoding, TV output, or the ability to connect multiple monitors. The video card may be any processing circuitry described above in relation to control circuitry 104. The video card may be integrated with the control circuitry 104. Speakers 114 may be provided as integrated with other elements of user equipment device 100 or may be stand-alone units. The audio component of videos and other content displayed on display 112 may be played through speakers 114. In some embodiments, the audio may be distributed to a receiver (not shown), which processes and outputs the audio via speakers 114. User equipment device 100 may also incorporate or be accessible to one or more other modules 116. For example, a content identification module 116 for identifying visual content, for example.

The media guidance application may be implemented using any suitable architecture. For example, it may be a stand-alone application wholly implemented on user equipment device 100. In such an approach, instructions of the application are stored locally (e.g., in storage 108), and data for use by the application is downloaded periodically (e.g., from an out-of-band feed, from an Internet resource, or using another suitable approach). Control circuitry 104 may retrieve instructions of the application from storage 108 and process the instructions to generate any of the displays discussed herein. Based on the processed instructions, control circuitry 104 may determine what action to perform when input is received from input interface 110. For example, movement of a cursor on a display up/down may be indicated by the processed instructions when input interface 110 indicates that an up/down button was selected.

In some embodiments, the media guidance application is client-server-based. Data for use by a thick or thin client implemented on user equipment device 100 is retrieved on-demand by issuing requests to a server remote to the user equipment device 100. In one example of a client-server-based guidance application, control circuitry 104 runs a web browser that interprets web pages provided by a remote server. For example, the remote server may store the instructions for the application in a storage device. The remote server may process the stored instructions using circuitry (e.g., control circuitry 104) and generate the displays discussed above and below.

The client device may receive the displays generated by the remote server and may display the content of the displays locally on equipment device 100. This way, the processing of the instructions is performed remotely by the server while the resulting displays are provided locally on equipment device 100. Equipment device 100 may receive inputs from the user via input interface 110 and transmit those inputs to the remote server for processing and generating the corresponding displays. For example, equipment device 100 may transmit a communication to the remote server indicating that an up/down button was selected via input interface 110. The remote server may process instructions in accordance with that input and generate a display of the application corresponding to the input (e.g., a display that moves using a cursor up/down). The generated display is then transmitted to equipment device 100 for presentation to the user.

In some embodiments, the media guidance application is downloaded and interpreted or otherwise run by an interpreter or virtual machine (run by control circuitry 104). In some embodiments, the guidance application may be encoded in the ETV Binary Interchange Format (EBIF), received by control circuitry 104 as part of a suitable feed, and interpreted by a user agent running on control circuitry 104. For example, the guidance application may be an EBIF application. In some embodiments, the guidance application may be defined by a series of JAVA-based files that are received and run by a local virtual machine or other suitable middleware executed by control circuitry 104. In some of such embodiments (e.g., those employing MPEG-2 or other digital media encoding schemes), the guidance application may be, for example, encoded and transmitted in a MPEG-2 object carousel with the MPEG audio and video packets of a program.

User equipment device 100 of FIG. 1 can be implemented in system 200 of FIG. 2 as user television equipment 202, user computer equipment 204, wireless user communications device 206, or any other type of user equipment suitable for accessing content. For simplicity, these devices may be referred to herein collectively as user equipment or user equipment devices and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 1 may not be classified solely as user television equipment 202, user computer equipment 204, or a wireless user communications device 206. For example, user television equipment 202 may, like some user computer equipment 204, be Internet-enabled allowing for access to Internet content, while user computer equipment 204 may, like some television equipment 202, include a tuner allowing for access to television programming. The media guidance application may have the same layout on various types of user equipment or may be tailored to the display capabilities of the user equipment. For example, on user computer equipment 204, the guidance application may be provided as a website accessed by a web browser. In another example, the guidance application may be scaled down for wireless user communications devices 206.

In system 200, there may be more than one type of user equipment device but only one of each is shown in FIG. 2 to avoid overcomplicating the drawing. In addition, each user may utilize more than one type of user equipment device and also more than one type of user equipment device. In some embodiments, a user equipment device (e.g., user television equipment 202, user computer equipment 204, wireless user communications device 206) may be referred to as a “second screen device” or “secondary device”.

The user may also set various settings to maintain consistent media guidance application settings, e.g., volume settings, across in-home devices and remote devices. Settings include programming preferences that the guidance application utilizes to make programming recommendations, display preferences, and other desirable guidance settings. For example, if a user sets a preferred volume level as a favorite volume level on, for example, a website mobile phone, the same settings would appear on the user's in-home devices (e.g., user television equipment and user computer equipment), if desired. Therefore, changes made on one user equipment device can change the guidance experience on another user equipment device, regardless of whether they are the same or a different type of user equipment device.

The user equipment devices may be coupled to communications network 214. Namely, user television equipment 202, user computer equipment 204, and wireless user communications device 206 are coupled to communications network 214 via communications paths 208, 210, and 212, respectively. Communications network 214 may be one or more networks including the Internet, a mobile phone network, mobile voice or data network (e.g., a 4G or LTE network), cable network, public switched telephone network or other types of communications network or combinations of communications networks. Paths 208, 210, and 212 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths.

Path 212 is drawn with dotted lines to indicate that in the exemplary embodiment shown in FIG. 2 it is a wireless path and paths 208 and 210 are drawn as solid lines to indicate they are wired paths (although these paths may be wireless paths if desired). Communications with the user equipment devices may be provided by one or more of these communications paths, but are shown as a single path in FIG. 2 to avoid overcomplicating the drawing.

Although communications paths are not drawn between user equipment devices, these devices may communicate directly with each other via communication paths, such as those described above in connection with paths 208, 210, and 212, as well as other short-range point-to-point communication paths, such as USB cables, IEEE 1394 cables, wireless paths (e.g., Bluetooth, infrared, IEEE 702-11x, etc.), or other short-range communication via wired or wireless paths. BLUETOOTH is a certification mark owned by Bluetooth SIG, INC. The user equipment devices may also communicate with each other directly through an indirect path via communications network 214.

System 200 includes content source 216 and media guidance data source 218 coupled to communications network 214 via communication paths 220 and 222, respectively. Paths 220 and 222 may include any of the communication paths described above in connection with paths 208, 210, and 212. Communications with the content source 216 and media guidance data source 218 may be exchanged over one or more communications paths, but are shown as a single path in FIG. 2 to avoid overcomplicating the drawing. In addition, there may be more than one of each of content source 216 and media guidance data source 218, but only one of each is shown in FIG. 2 to avoid overcomplicating the drawing. (The different types of each of these sources are discussed below.) If desired, content source 216 and media guidance data source 218 may be integrated as one source device. Although communications between sources 216 and 218 with user equipment devices 202, 204, and 206 are shown as through communications network 214, in some embodiments, sources 216 and 218 may communicate directly with user equipment devices 202, 204, and 206 via communication paths (not shown) such as those described above in connection with paths 208, 210, and 212.

Content source 216 may include one or more types of content distribution equipment including a television distribution facility, cable system headend, satellite distribution facility, programming sources (e.g., television broadcasters, such as NBC, ABC, HBO, etc.), intermediate distribution facilities, and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 216 may be the originator of content (e.g., a television broadcaster, a Webcast provider, etc.) or may not be the originator of content (e.g., an on-demand content provider, an Internet provider of content of broadcast programs for downloading, etc.). Content source 216 may include cable sources, satellite providers, on-demand providers, Internet providers, over-the-top content providers, or other providers of content. Content source 216 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 218 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

Media guidance applications may be, for example, stand-alone applications implemented on user equipment devices. For example, the media guidance application may be implemented as software or a set of executable instructions which may be stored in storage 108, and executed by control circuitry 104 of a user equipment device 100. In some embodiments, media guidance applications may be client-server applications where only a client application resides on the user equipment device, and server application resides on a remote server. For example, media guidance applications may be implemented partially as a client application on control circuitry 104 of user equipment device 100 and partially on a remote server as a server application (e.g., media guidance data source 218) running on control circuitry of the remote server. When executed by control circuitry of the remote server (such as media guidance data source 218), the media guidance application may instruct the control circuitry to generate the guidance application displays and transmit the generated displays to the user equipment devices. The server application may instruct the control circuitry of the media guidance data source 218 to transmit data for storage on the user equipment. The client application may instruct control circuitry of the receiving user equipment to generate the guidance application displays.

Content and/or media guidance data delivered to user equipment devices 202, 204, and 206 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. YouTube is a trademark owned by Google Inc., Netflix is a trademark owned by Netflix Inc., and Hulu is a trademark owned by Hulu, LLC. OTT. In addition to content and/or media guidance data, providers of OTT content can distribute media guidance applications (e.g., web-based applications or cloud-based applications), or the content can be displayed by media guidance applications stored on the user equipment device.

Media guidance system 200 is intended to illustrate various approaches, or network configurations, by which user equipment devices and sources of content and guidance data may communicate with each other to access content and provide media guidance. The embodiments described herein may be applied in any approach that does not deviate from the teachings of this disclosure, for example in a system employing an approach for delivering content and providing media guidance.

In an example approach, user equipment devices may operate in a cloud computing environment to access cloud services. In a cloud computing environment, various types of computing services for content sharing, storage, or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 214. These cloud resources may include one or more content sources 216 and one or more media guidance data sources 218. In addition or in the alternative, the remote computing sites may include other user equipment devices, such as user television equipment 202, user computer equipment 204, and wireless user communications device 206. For example, the other user equipment devices may provide access to a stored copy of a video or a streamed video.

The cloud provides access to services, such as content storage, content sharing, or social networking services, among other examples, as well as access to any content described above, for user equipment devices. Services can be provided in the cloud through cloud computing service providers, or other providers of online services. For example, cloud-based services can include a content storage service, a content-sharing site, a social networking site, or other services via which user-sourced content is distributed for viewing by others on connected devices. These cloud-based services may allow a user equipment device to store content to the cloud and to receive content from the cloud rather than storing content locally and accessing locally stored content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 1.

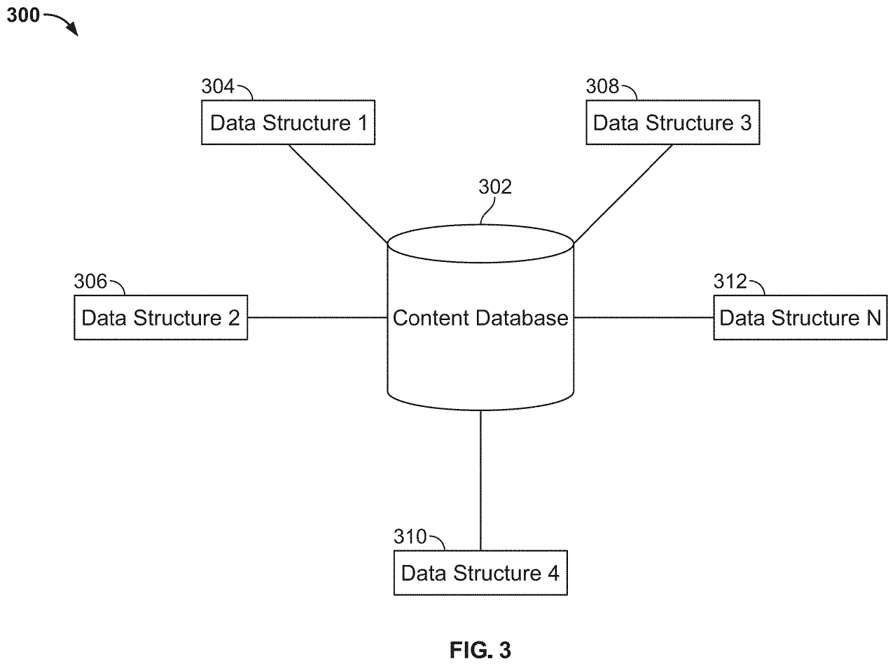

As shown in the example of FIG. 3, there may be more than one type of data structure, e.g., data structures 1 to N as shown in FIG. 3 as 304, 306, 308, 310, and 312 for illustration purposes only, all connected to a content database 302. Data structures may additionally be connected to one or more other content databases. In some examples, content database 302 is the backend or storage of a media platform such as a social media platform, news media platform, a search engine, or the like.

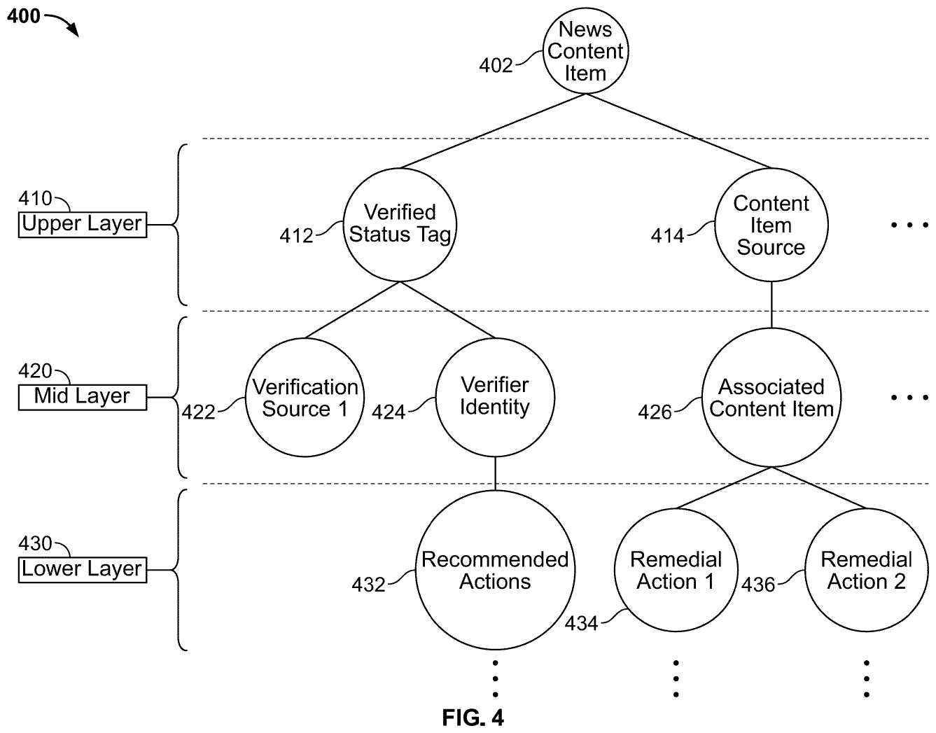

FIG. 4 shows an example data structure, in accordance with various embodiments described herein. Only one example data structure is shown in FIG. 4 for illustration purposes and to avoid overcomplicating the drawing. Furthermore, it will be appreciated that FIG. 4 is a further simplification of a data structure, and it will be appreciated that any other non-linear data structure may be implemented without diverting from the teachings of the present disclosure, e.g., a graph data structure, a Merkle Tree data structure, or the like.

An example tree data structure is shown in FIG. 4. A tree, as it is known in the art, is a collection of data items typically represented as nodes and is a non-linear data structure that arranges data items in sorted order, e.g., by arranging content items in order of chronology, relevance, or significant changes. Such a data structure can be used to understand a hierarchical structure between various data elements and organize the data into branches that relate the information of various content items. There are several types of tree data structures, such as a binary tree, binary search tree, AVL, tree, threaded binary tree, B-tree, Merkle Tree, etc., any of which may be implemented in relation to embodiments described herein without diverting from the teachings of the present disclosure.

There are various terms known in the art that are associated with tree data structures and, in the context of the present disclosure, any suitable term may be used. In the example of FIG. 4, a data set describing a content item, typically a news content item 402, is provided as a root node or root element of data structure 400. In some examples, the tree data structure comprises multiple layers or levels 410, 420, 430, as will be described in more detail below. In some examples, the data structure comprises intermediary nodes representative of, for example, verification status 412, a content item source 414, empty nodes (not shown), verification source 422, verifier identity 424, associated content item 426, recommended actions 432, and remedial actions 434, 436. Each of the nodes (source nodes, root nodes, and other intermediary nodes, such as empty nodes) may be connected with one or more other nodes by links or edges.

The digital world is constantly being bombarded with unstructured data, and one effective way to understand and verify content is to use artificial intelligence algorithms and tools. Unstructured data is all around us. For example, mass amounts of unstructured data can be seen on social media platforms, chatting platforms, websites, etc. Although the online world has created a data-rich and content-rich environment, trying to derive insights, such as determining whether a particular content item is reliable or factually correct, can be particularly difficult and time-consuming due to content items' unstructured nature and the required levels of analysis, organizing and filtering involved.

In view of the foregoing, the present disclosure proposes an efficient and effective algorithm that may be used to identify and/or monitor the spread of misleading, false, or unreliable content, e.g., on social media websites, on search engines, and in a messaging application. In addition, the present disclosure provides systems and methods for prioritizing known verified true content items in a search function, which may also indicate and warn users about misleading, fake, or false content items. For example, a newly published article or news story on a media platform (e.g., social media, messaging application, or news search engine) is monitored, and a rate of sharing of the content item on the media platform is determined. If the rate of sharing passes a threshold, a data set describing the content item is created and sent for verification. The verification comprises creating a non-linear data structure stored in a blockchain that enables a chain of command on the content item, which will be described in more detail below. Accordingly, a potentially so-called “fake” news story comprises misleading information that can be identified, marked for verification, verified true or false by a trusted entity, and this information can form the basis of a series of remedial actions, indications, and prioritizing search results.

In some embodiments, to verify a content item, when the content item is input into the method (e.g., an algorithm), it may be tagged or labeled as “true” or as “fake,” for example. The system may then implement embodiments described herein to prove whether the given content item is “relevant” or “irrelevant,” “reliable” or “unreliable,” “real” or “fake,” or “misleading,” for example.

In more detail, as shown in FIG. 4, a content item, in this case, a news content item 402, forms the root of the non-linear data structure 400. In the upper layer 410, which is an arbitrary label given to the first layer below the root node 402, a plurality of nodes may be created and linked to the root node. For example, a verified status tag node 412 can indicate whether the news content item is true or misleading, and a content item source node 414 can provide information of the original source, or a first source, of the news content item. The information in the upper layer 410 comprises the basic information that may be already be known at the time the root node 402 is created and can therefore be created at the same time by the system. Although only two nodes are shown in FIG. 4, it should be understood that this is a simplified illustration and many more nodes may be present. In some examples, nodes created in the upper layer 410 may only be based on information contained within the news content item 402.

The mid-layer 420 comprises an additional plurality of nodes that are linked to nodes within the upper layer 410. For example, linked to the verified status tag node 412 in the upper layer 410 may be a verification source node 422 and a verifier identity node 424. These nodes provide the source a user who committed the verification status of the news content item 402 used, and their details, respectively. The verifier identity node 424 may comprise information such as a name of the user, or wherein the user is an entity (e.g., a trusted news site) and the name of the entity; a reputation score of the user; time stamps; or other such necessary information to validate the user or entity committing the change. In some examples, the aforementioned information may be reflected in a node further down the tree linked to the verifier identity node 424.

The mid-layer may also comprise an associated content item node 426. For example, there may be a plurality of versions or copies found on multiple media platforms of the same content items 402. Accordingly, the associated content item node 426 is linked to the content item source 414 of the upper layer 410. There may be a plurality of associated content item nodes 426.

The lower layer 430 of non-linear data structure 400 may comprise a recommended action node 432 linked to the verifier identity or the verification status of the news content item node 402. In addition, the lower layer 430 may comprise remedial action nodes 434-436, which describe actions taken on the platforms to show actions taken regarding a news content item. In some examples, the remedial actions are automatically carried out on the platform after the recommended action node is created.

An example of recommended action to be taken or remedial actions taken include searching a user device for the content item, the hash value of the content item, or a unique identifier of the content item. In response to finding the content item wherein the content item is tagged as fake, false, or misleading, the user can be informed that they have consumed or may have consumed such a content item. In some examples, the user is provided with a headline or some reference information, as well as the date and time of consumption. In addition, in some examples, the user is then provided the true or verified true associated content item.

Another example of a recommended or remedial action includes informing local governmental bodies, non-governmental organizations, police, news outlets, and media platforms of the content item and information regarding the spread of the content item.

Another example of a recommended or remedial action includes tagging the content item with certain indicators such as forwarding indicators, information indicators, verified false or verified true indicators.

Another example of a recommended or remedial action includes removing the content item from the media platform.

Another example of a recommended or remedial action includes changing, replacing, or updating the hyperlink of the content item marked as false with a hyperlink of an associated story marked as true.

Another example of a recommended or remedial action includes preventing the forwarding of the content item on a media platform. In addition, if the user has already forwarded the content item, the system may auto-forward an associated content item that is verified true to the same location, for example, auto-forwarding an article link to a group chat or social media profile.

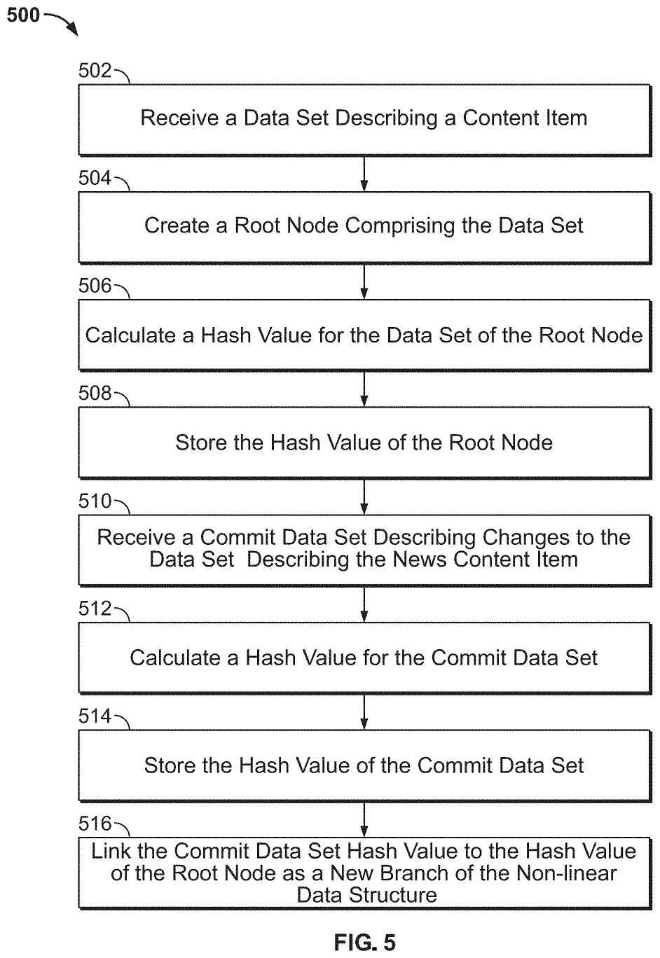

FIG. 5 is a flowchart of illustrative steps involved in creating a non-linear data structure, and calculating and storing hash values of the nodes of the non-linear data structure, in accordance with some embodiments of the present disclosure. In addition, one or more steps of process 500 may be incorporated into or combined with one or more steps of any other process or embodiment disclosed herein.

At step 502, the system receives a data set describing a content item. In example embodiments, the root node of the data structure may represent a content item such as an article, a news story, a news article, a blog post, a chain email, a chain message, or the like. In some examples, source content items may be received from any of a broadcast, a news provider, an online news platform, an online blog, a social media platform, and/or a group within a social media platform. Sources can also include shows on cable TV networks, radio shows, or national newspapers, as well as digital news outlets that syndicate content from a plurality of sources. Source content items may be content items generated by reputed outlets of information and/or sources that are defined to be “reliable,” “unreliable,” or known fake news sources.

The plurality of other content items for the data structure may be received from any of a broadcast, a news provider, an online news platform, an online blog, a social media platform, and/or a group within a social media platform. Content items can also include shows on cable TV networks, radio shows, national newspapers, as well as digital news outlets. Content items may be retrieved from any outlet of information and may include online posts by users, for example. It will be appreciated that content items may be differentiated from source content items by any of the following: upload time, source, and/or content platforms. For example, source items may be content items that were uploaded first and/or generated from sources of a defined level of reliability, and other content items may be content items that are uploaded at a later point in time and/or generated from sources of an undefined level of reliability. Content items may also be related to the source that has generated the source items and thus are associated with source items in this way.

In a specific example, a news content item, e.g., an article about Covid-19 vaccines, may be published on a known so-called fake news site and shared on social media, creating worry and fear among those that consume the article. As the article is shared, and the sharing of the article passes a threshold, a data set will be sent to the system describing the news content item. In some examples, the data set is data of arbitrary size, known in the art as the “message” of a cryptographic hash function.

In some examples, determining the data set may be based on a method comprising monitoring a rate of sharing of a content item on the media platform. In response to the rate of sharing reaching a threshold, a data set describing the content item, and is created and sent for verification. In some examples, identifying the content item may be based on existing natural language processing technologies, such as supervised machine learning algorithms that can classify documents.

At step 504, the system creates a root node of the blockchain comprising the data set. A blockchain is a continuously growing list of records, called blocks, that are linked and secured using cryptography. Each block typically contains a hash pointer as a link to a previous block, a time stamp, and transaction data. By design, blockchains are inherently resistant to modification of the data, and are considered to be an open, distributed ledger that can record transactions between two parties efficiently and in a verifiable and permanent way. For use as a distributed ledger, a blockchain is typically managed by a peer-to-peer network collectively adhering to a protocol for validating new blocks, which will be described in more detail below. Once recorded, the data in any given block cannot be altered retroactively without the alteration of all subsequent blocks, which requires the collusion of the network majority. Blockchains are secure by design and are an example of a distributed computing system with high Byzantine fault tolerance. Decentralized consensus has therefore been achieved with a blockchain.

At step 506, the system calculates a hash value for the data set of the root node. The hash value may be calculated using any known hashing algorithms such as MDS, SHA-0, SHA-1, SHA-2, Keccak, SHA-3, NTLM, and LANMAN, including future versions and precursors to these hashing algorithms. For example, the SHA-256 hashing algorithm may be used to obtain a 256-bit binary number, the hash value, or a hexadecimal representation of the hash value. A cryptographic hash function is a mathematical algorithm that maps data of arbitrary size (often called the “message”) to a bit array of a fixed size (the “hash value,” “hash,” or “message digest”). It is a one-way function, that is, a function that is practically infeasible to invert or reverse. Ideally, the only way to find a message that produces a given hash is to attempt a brute-force search of possible inputs to see if they produce a match, or use a rainbow table of matched hashes. Cryptographic hash functions are a basic tool of modern cryptography, and all hash functions are considered within the scope of this disclosure.

At step 508, the system stores the hash value of the root node on the blockchain. In some examples, the system may additionally store the hash value, or the non-linear data structure as a whole in, storage 108, as described with reference to FIG. 1 above.

At step 510, the system receives a commit data set describing changes to the data set describing the news content item. In some examples, the commit data set comprises an indication of a verification status tag. In some examples, the verification status tag is at least one of: relevant, irrelevant, reliable, unreliable, real, fake, or misleading. The commit data set is received from a trusted user, entity (e.g., BBC, Sky News, etc.), or governmental authority (e.g., SAGE, Department of Health, etc.)—referred to collectively as a trusted user.

For example, in the specific example of an article about Covid-19 vaccines, which is being shared on social media, when the rate of sharing reaches a threshold, the trusted user can verify the story and create a commit data set, which may include, for example, a source for the verification, an indication of the verification tag, author information, time stamps, and the like. In some examples, content items, e.g., articles, may be analyzed and verified based on any one or a combination of context, popularity, a quality, a level of professionalism, researched public sentiment, a number of views, a number of followers, a number of likes, a source, an author, a historical classification of the source, a historical classification of the author, one or more similar source items, one or more associated source items, confidence scores of one or more associated content items, a location of its viewers, a link, a reference, and/or relevance to a verified content item. For example, a short article about U.S. politics relating to a specific U.S. state, e.g., New York, that gets retweeted or liked by people in a different region, e.g., Europe, may be less likely to be a strong indicator of the reliability of the article compared to the activity of U.S. users from that specific U.S. state. Thus, in some embodiments, one or more factors associated with the verification process may be included in the commit data set.

At step 512, the system calculates a hash value for the commit data set. A hash value can be calculated in the same way as described above with reference to step 506. At step 514, the system stores the hash value of the commit data set on the blockchain. In some examples, the system may additionally store the hash value, or the non-linear data structure as a whole, in storage 108 as described with reference to FIG. 1 above. For example, each commit data set hash value may be stored in the data structure and represented by suitably placed intermediary nodes based on each of their associations with any other node. In more detail, a commit data set closely relating to a particular source item may be represented by an intermediary node that is associated with the source node representing the said source item. For example, each intermediary node may be displaced in a layer of the data structure with respect to the root node.

Accordingly, at step 516, the system links the commit data set hash value to the hash value of the root node as a new branch of the non-linear data structure. In some examples, a Merkle proof may be used to incrementally validate branches of the non-linear data structure to determine if a branch has been modified. Merkle proofs are used to determine if the data belongs in the non-linear data structure or tree, to concisely prove the validity of data being part of a dataset without storing the whole data set, and to ensure the validity of a certain data set being inclusive in a larger data set without revealing either the complete data set or its subset. Merkle trees make extensive use of one-way hashing. Merkle proofs are established by hashing a hash's corresponding hash together and climbing up the tree until you obtain the root hash, which is or can be publicly known. Given that one-way hashes are intended to be collision-free and deterministic algorithms, no two plaintext hashes can/should be the same. Merkle trees are extensively used to prove inclusivity in large datasets and the majority of blockchain applications.

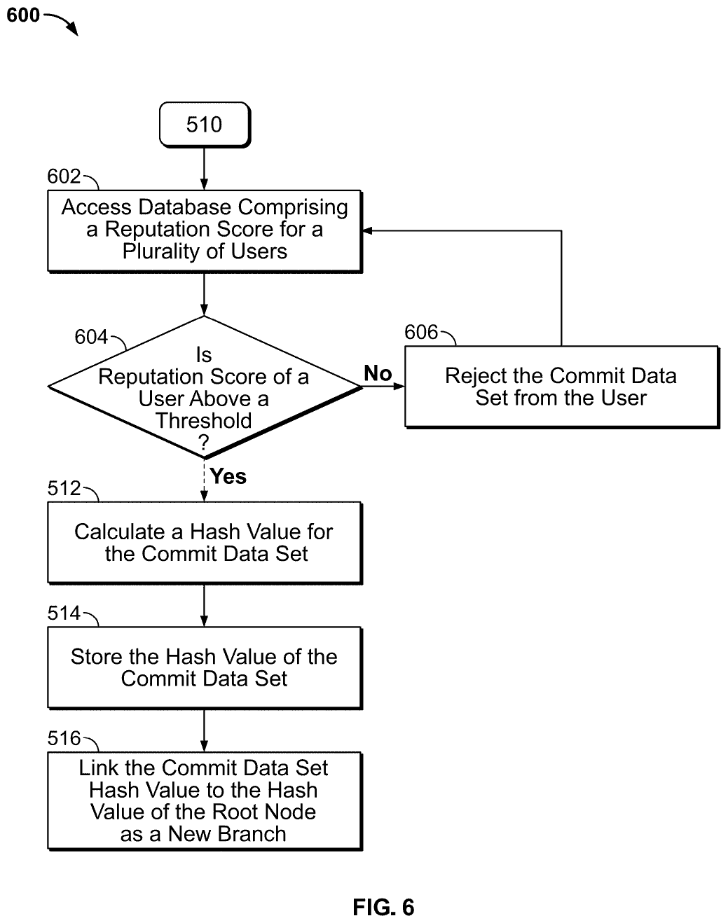

FIG. 6 is a flowchart of illustrative steps involved in accessing a database comprising a reputation score for a plurality of users and determining if the reputation score for a particular user is above a threshold, in accordance with some embodiments of the present disclosure. In addition, one or more steps of process 600 may be incorporated into or combined with one or more steps of any other process or embodiment disclosed herein. As shown, process 600 may follow step 510 of process 500. Process 600 is considered an additional process to 500 to improve security against malicious tampering.

At step 602, the system accesses a database comprising a reputation score for a plurality of users. The database may be stored in storage 108, as described with reference to FIG. 1. At step 604, the system determines if the reputation score of the user providing the commit data set, as described in step 510, is above a threshold. If the answer to step 604 is no, process 600 continues to step 606. At step 606, the system rejects the commit data set from the user and returns to step 602, or step 510, or ends the process.

If the answer to step 604 is yes, process 600 may continue to step 512. However, step 512 may be carried out in parallel to process 600. In some examples, when processes 500 and 600 are being carried out in parallel, if the answer to step 604 is no, and any steps beyond 510 of process 500 have been carried out, for example, calculating the hash value for the commit data set, any stored hash values, or any links created, are purged from the system.

In some examples, the system optionally creates an empty node to be filled by the hash value of the commit data set if the response to step 604 is yes, and the empty node can remain unfilled if the answer to step 604 is no. In some embodiments, where a data structure does not yet comprise certain nodes, in any of the layers of the data structure, empty nodes may be used to show that certain data has not been obtained, which may later be replaced or updated by the nodes as described with reference to FIG. 4.

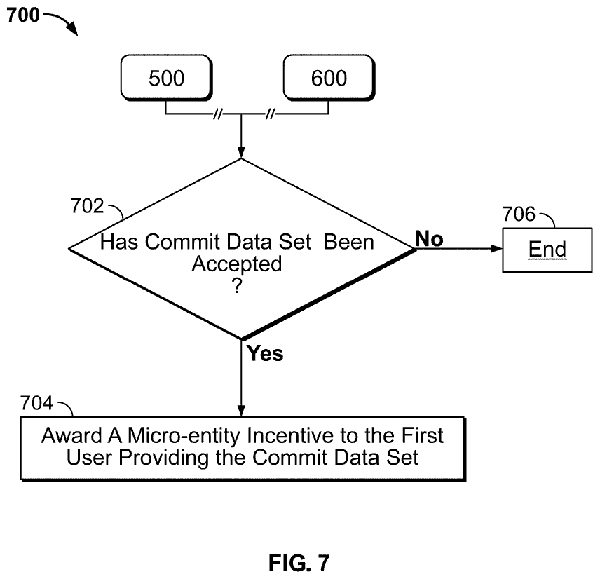

FIG. 7 is a flowchart of illustrative steps in awarding a micro-entity incentive to a user providing a commit data set, in accordance with some embodiments of the present disclosure. In addition, one or more steps of process 700 may be incorporated into or combined with one or more steps of any other process or embodiment disclosed herein. In particular, as shown, process 700 may be carried out in parallel to process 500 and/or process 600.

At step 702, the system determines if the commit data set has been accepted and, in some examples, stored in the non-linear data structure. If the answer to step 702 is yes, process 700 continues on to step 704. At step 704, the system awards a micro-entity incentive to the first user providing the commit data set. That is to say that, for example, a user who provides a commit data set that is hashed, stored, and linked to another node on the non-linear data structure is awarded a micro-entity incentive, such as a crypto-currency or non-fungible token (NFT).

If the answer to step 702 is no, process 700 ends. In some examples, after process 700 ends, the system returns to process 500 or 600. In some examples, process 700 further comprises accepting the commit data set describing changes to the data set describing the news content item from a first user.

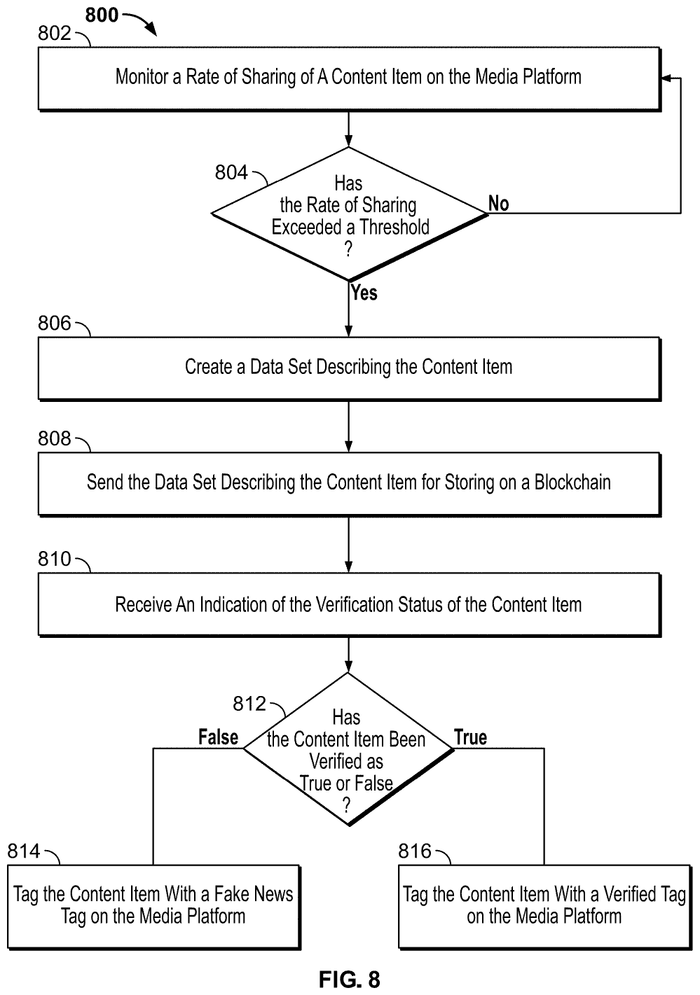

FIG. 8 is a flowchart of illustrative steps involved in determining if the rate of sharing of a content item exceeds a threshold and tagging the content item in response to the content item being verified true or false, in accordance with some embodiments of the present disclosure. In addition, one or more steps of process 800 may be incorporated into or combined with one or more steps of any other process or embodiment disclosed herein. In particular, process 800 may be carried out in parallel to processes 500, 600, and 700.

At step 802, the system monitors the rate of sharing of a content item on the media platform. For example, a news content item is posted to the platform and the sharing of the content item is monitored. The rate of sharing is based on at least one of popularity, a number of views, a number of likes, a number of impressions, a number of quotes, a number of times forwarded, a number of comments, a number of favorites, or a number of interactions.

At step 804, the system determines if the rate of sharing has exceeded a threshold. In some examples, the threshold is specific to the media platform the content item is shared on. For example, on any given platform, there will be a baseline sharing growth factor for any given post based on the number of followers or friends a person has; therefore, the threshold will be an anomaly to this baseline.

In some examples, the threshold is a particular number of views, a number of likes, a number of impressions, a number of quotes, a number of times forwarded, a number of comments, a number of favorites, or a number of interactions. In this way, the rate of sharing can be directly measured against the threshold by any one or more of these metrics.

In some examples, the spread of known fake news stories can be modeled and compared to the normal spread of a typical content item. Accordingly, the rate of sharing of any given content item can be plotted against the model of known fake news growth and the potential fake news stories can be predicted to a high degree of accuracy. At this stage, however, it would be unclear if the content item is fake, or whether it is popular (e.g., viral) content—hence the need for verifying the content. In this way, and in some examples, whether a content item is fake or not, all content spreading at a particularly fast rate will be monitored and verified by a trusted user.

If the answer to step 804 is no, process 800 returns to step 802. If the answer to step 804 is yes, process 800 continues to step 806. Alternatively, in some examples, a user with a reputation score above a threshold may select a content item to be verified and push through the content item to step 806 irrespective of the outcome of step 804 and/or without the monitoring of step 802.

At step 806, the system creates a data set describing the content item. The data set, known in the art as the “message,” of a cryptographic hash function may be data of arbitrary size, as described above with reference to FIG. 5.

At step 808, the system sends the data set describing the content item for storing on a blockchain. In some examples, the sending of the data set for storing may be interchangeably replaced by sending of the data set for verification. Between steps 808 and 810, any of the steps in processes 500, 600, or 700 may be carried out in full, partially, or in parallel to process 800.

At step 810, the system receives an indication of the verification status of the content item. The verification status may be any one of relevant, irrelevant, reliable, unreliable, real, fake, true, false, or misleading—or any other equivalent synonym. At step 812, the system determines if the content item has been verified as true or false.

In response to the content item being verified as false, fake, misleading, or the like, process 800 moves on to step 814, in which the system tags the content item with a misleading news tag on the media platform. In response to the content item being verified as true, reliable, real, or the like, process 800 moves on to step 816, in which the system tags the content item with a verified tag on the media platform.

In some examples, the system continues to monitor the rate of sharing of a content item after the content item has been tagged to determine the consumption of the fake news over time. For example, a content item that is verified fake may continue to spread, whereas a second content item that is verified true may not reach as many consumers. In this way, efforts can be made by governmental bodies or non-governmental organizations (NGOs) to raise awareness of the truth.

In some examples, the monitoring of the rate of spread may also include monitoring the geographical region of the spreading of the content item. In this way, the area of spread can be used to determine targeted actions to be taken (e.g., remedial and recommended actions in FIG. 4)

In some alternative examples, the tagging comprises assigning a non-fungible token (NFT) to the content time. For example, a piece of content of interest is assigned a non-fungible token, which is then used to track the further forwarding of the content item.

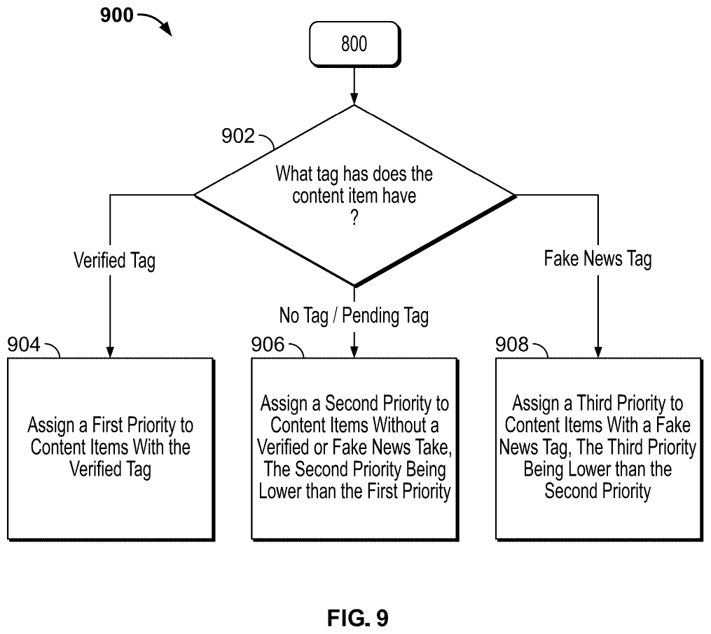

FIG. 9 is a flowchart of illustrative steps involved in assigning a priority tag to a content item based on a verified tag status, in accordance with some embodiments of the present disclosure. In addition, one or more steps of process 900 may be incorporated into or combined with one or more steps of any other process or embodiment disclosed herein. In particular, as shown, process 900 may follow on from, or be carried out in parallel to, process 800 or any of processes 500, 600, and 700 (not shown), where appropriate.

At step 902, the system determines what type of tag a content item has, such as a verified tag (e.g., true, real, reliable, etc.), a misleading news tag (e.g., false, fake, misleading, etc.), or indeed no tag or is pending a tag—found in the upper layer 410, as shown with reference to FIG. 4.

If the answer to step 902 is that a content item has a verified tag, process 900 continues to step 904. At step 904, the system assigns a first priority to content items with the verified tag.

If the answer to step 902 is that a content item does not have a tag or is pending a tag (e.g., awaiting a tag to be assigned through the verification processes as described herein), process 900 continues on to step 906. At step 906, the system assigns a second priority to content items without a verified or misleading news tag, wherein the second priority is lower than the first priority.

If the answer to step 902 is that a content item has a misleading news tag, the system assigns a third priority to content items with a misleading news tag, the third priority being lower than the second priority.

In this way, in some examples, in response to a search being performed on a media platform or user device, the system can prioritize the search results according to the assigned priority of the content items as described above. Therefore, content items with the verified tag will always be shown to a user over content items without a tag, and especially over those that are known to be misleading.

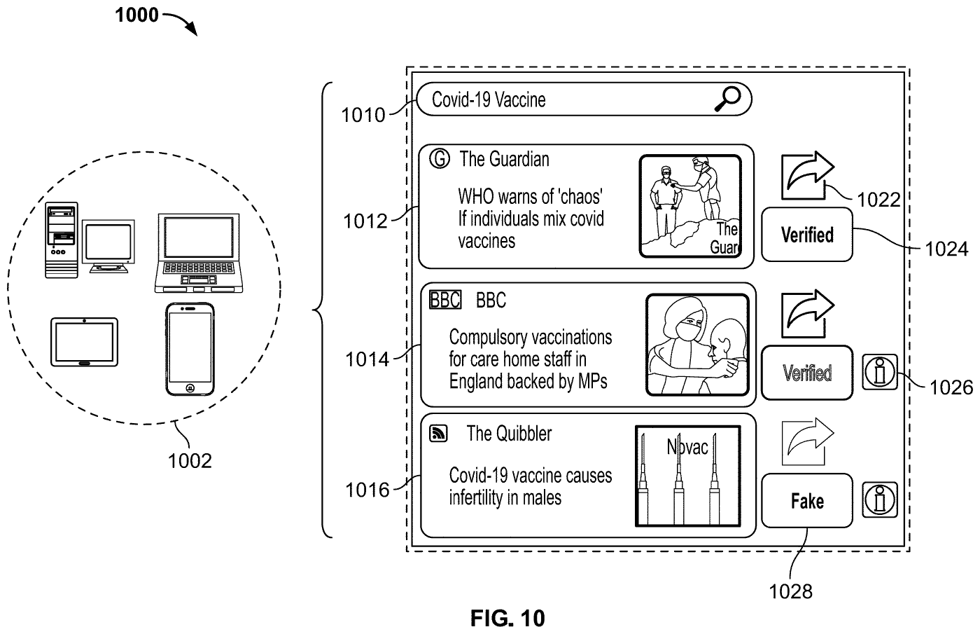

FIG. 10 shows an illustrative diagram of an example user interface comprising a search bar 1010 and search results 1012-1016 carried out on a user device 1002, in accordance with some embodiments of the present disclosure. Shown are a plurality of user devices 1002. User device 1002 may be any one or more of a PC, a laptop, a smartphone, a tablet, a smartwatch, or the like.

In some embodiments, a visual indicator, such as visual indicators 1022-1028, may be displayed to notify the user of the status of a content item that is currently being displayed. For example, a forward indicator 1022 may be present to enable a user to forward the content item. In some examples, a verified indicator 1024 may also be present to inform the user that the content item has been verified as true. In some examples, an information indicator 1026 may be present to allow the user to click for more information about the verified status, such as the information stored in the non-linear data structure 400, or a subset thereof. In some examples, there may be a fake news indicator 1028 to inform the user that the associated search result, in FIG. 10 search results 1016, has been verified as fake, false, or misleading.

For example, as shown in FIG. 10, a user operating user device 1002 may search in search bar 1010 for the phrase “covid-19 vaccine,” which yields the top three search results 1012, 1014, and 1016. In the example, search result 1012 is shown as an article from the popular British Newspaper “THE GUARDIAN” with the title, “WHO warns of ‘chaos’ if individuals mix Covid vaccines.” This is a good example of an attention-grabbing headline that ultimately does not indicate if the content therein is true or false. In this example, verified indicator 1024 shows that, indeed, the article is true.

In another example shown in FIG. 10, search results 1014 is shown as an article from the BBC (the British Broadcast Corporation), the state-funded media outlet with the title, “Compulsory vaccinations for care home staff in England backed by MPs.” In this example, the verified indicator is greyed out to indicate that the content item is likely to be true, as this is a known trusted news outlet, but has not yet been verified as such. A similar greyed-out indicator could be shown for a known fake news outlet.

In yet another example shown in FIG. 10, search result 1016 is shown as an article from “The Quibbler,” a news outlet known for posting fake news stories to sell copies of its magazine with the title, “Covid-19 vaccine causes infertility in males.” In this example, the fake news indicator 1028 shows that the story is, indeed, false. Accordingly, the forward indicator has been greyed out to prevent the user from spreading the news further.

In some examples, the user is not prevented from accessing the source of the information. In some examples, the content items with the fake news indicator 1028 may still be forwarded; however, in such examples, the fake news indicator 1028 will always be displayed as this cannot be removed once issued on the non-linear data structure stored on the blockchain, at least not without consensus.

In some examples, if a user has already forwarded the content item while, for example, the content item was pending verification, such as is the case with search result 1014, the system may automatically update the non-linear data structures with the source of the associated content items. In some examples, while a user is consuming a content item on user device 1002, a notification may be displayed for the user during the consumption of media content comprising the fake news indicator 1028. For example, upon determining that the content item is indeed fake news, a media guidance application may show a notification, e.g., a pop-up notification, with a visual indicator or message to notify the user that the contents of the content source are false.

Some embodiments of the present disclosure may be integrated into any system or platform where content items are shared among users. For example, embodiments described herein may be integrated into social media platforms where the sharing of content items is vast and uncontrollable. Embodiments described herein may also be integrated into chatting applications for a more informative discussion between users within the chat. Additionally, or alternatively, a system comprising embodiments described herein may be integrated into one or more user devices or one or more media guidance applications, for example.

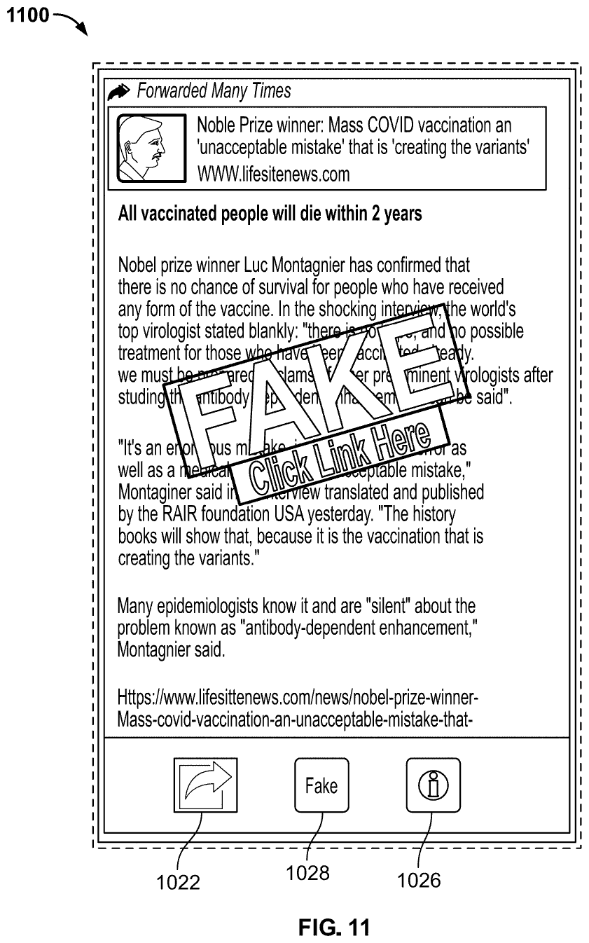

FIG. 11 shows an illustrative diagram of an example content item that has been tagged as fake news on a media platform, in accordance with some embodiments of the present disclosure. As shown in FIG. 11, a message 1100 on a media platform, such as a messaging application on a smartphone device, has been tagged as fake news. As such, forwarding indicator 1022 is greyed out and therefore prevents further forwarding of the message 1100; the fake news indicator 1028 is present; and information indicator 1026 is shown to allow the user to find the author of the verification (e.g., the verifier), the original content source item, and/or the verifier's content source.

In some embodiments, one or more of the data structures may be prioritized over another. For example, it may be that a particular event or topic has lost the interest of media content consumers and therefore is monitored less often relative to trending topics or events. Furthermore, in some embodiments, if a data structure does not carry any source items of high reliability, for example, that data structure may be assigned a low priority for updating or deemed irrelevant or factually incorrect over time.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes.

Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real-time.

It will be appreciated that the media guidance application may perform one or more of the functions described above simultaneously. It should also be noted, the systems and/or methods described above may be applied to, or used in accordance with, other systems and/or methods. Additionally any of the steps in said processes can be performed in any order, can be omitted, and/or can be combined with any of the steps from any other process.

While some portions of this disclosure may make reference to “convention,” any such reference is merely for the purpose of providing context to the invention(s) of the instant disclosure, and does not form any admission as to what constitutes the state of the art.

1. A method for providing a non-linear data structure stored in a blockchain database, the method comprising:
receiving a data set describing a content item;
creating a root node comprising the data set;
calculating a hash value for the data set of the root node;
storing the hash value of the root node;
receiving a commit data set describing changes to the data set describing the content item;
calculating a hash value for the commit data set;
storing the hash value of the commit data set; and
linking the commit data set hash value to the hash value of the root node as a new branch of the non-linear data structure.

2. The method of claim 1, further comprising:
wherein the commit data set comprises an indication of a verification status tag; and
wherein the verification status tag is one of: relevant, irrelevant, reliable, unreliable, real, fake, true, false, or misleading.

3. The method of claim 1, further comprising:
performing a Merkle proof to incrementally validate branches of the non-linear data structure to determine if a branch has been modified.

4. The method of claim 1, further comprising:
accessing a database comprising a reputation score for a plurality of users; and
wherein the commit data set is provided by a first user having a first reputation score.

5. The method of claim 4, further comprising:
determining that the first reputation score of the first user is above a threshold;
wherein the storing the hash value of the commit data set and the linking the commit data set hash value to the hash value of the root node are in response to the reputation score of the first user being above a threshold.

6. The method of claim 4, further comprising:
determining that the first reputation score of the first user is below a threshold; and
rejecting the commit data set from the first user.

7. The method of claim 6, further comprising:
receiving the commit data set describing changes to the data set described the news content item from a second user with a second reputation score;
determining that the second reputation score of the second user is above the threshold; and
wherein the storing the hash value of the commit data set and the linking the commit data set hash value to the hash value of the root node is in response to the reputation score of the first user being above a threshold.

8. The method of claim 1, wherein the blockchain database is maintained via trust-enabled adaptive mining.

9. The method of claim 1, further comprising:
accepting the commit data set describing changes to the data set describing the news content item from a first user; and
awarding a micro-entity incentive to the first user providing a commit data set.

10. The method of claim 1, wherein the commit data set comprises one or more of: an indication that the content item is true or false, authorship information, verifier information, or a link to associated news content items, or timestamp data.

11. The method of claim 1, further comprising:
monitoring a rate of sharing of a content item on a media platform;
in response to the rate of sharing reaching a threshold:
creating a data set describing the content item;
sending the data set describing the content item for verification; and
in response to the content item being verified as misleading:
tagging the content item with a misleading news tag on the media platform.

12. A system for providing a non-linear data structure stored in a blockchain database, the system comprising:
means for receiving a data set describing a news content item;
means for creating a root node comprising the data set;
means for calculating a hash value for the data set of the root node;
means for storing the hash value of the root node;
means for receiving a commit data set describing changes to the data set describing the news content item;
means for calculating a hash value for the commit data set;
means for storing the hash value of the commit data set; and
means for linking the commit data set hash value to the hash value of the root node as a new branch.

13. The system of claim 12, further comprising:
wherein the commit data set comprises an indication of a verification status tag;
wherein the verification status tag is one of: relevant, irrelevant, reliable, unreliable, real, fake, or misleading.

14. The system of claim 12, further comprising:
means for performing a Merkle proof incrementally validate branches of the non-linear data structure to determine if a branch has been modified.

15. The system of claim 12, further comprising:
means for accessing a database comprising a reputation score for a plurality of users; and
wherein the commit data set is provided by a first user having a first reputation score.

16. The system of claim 15, further comprising:
means for determining that the first reputation score of the first user is above a threshold;
wherein the means for storing the hash value of the commit data set and the means for linking the commit data set hash value to the hash value of the root node are used in response to the reputation score of the first user being above a threshold.

17. The system of claim 15, further comprising:
means for determining that the first reputation score of the first user is below a threshold; and
means for rejecting the commit data set from the first user.

18. The system of claim 17, further comprising:
means for receiving the commit data set describing changes to the data set described the news content item from a second user with a second reputation score;
means for determining that the second reputation score of the second user is above the threshold; and
wherein the storing the hash value of the commit data set and the linking the commit data set hash value to the hash value of the root node are used in response to the reputation score of the first user being above a threshold.

19. The system of claim 12, wherein the blockchain database is maintained via trust-enabled adaptive mining.

20-22. (canceled)

23. A non-transitory computer-readable medium comprising non-transitory computer-readable instructions encoded thereon for providing a non-linear data structure stored in a blockchain database, the instructions comprising:
receiving a data set describing a news content item;
creating a root node comprising the data set;
calculating a hash value for the data set of the root node;
storing the hash value of the root node;
receiving a commit data set describing changes to the data set describing the news content item;
calculating a hash value for the commit data set;
storing the hash value of the commit data set; and
linking the commit data set hash value to the hash value of the root node as a new branch.

24-60. (canceled)
